(19) United States
(12) Patent Application Publication
(10) Pub. No.: US 2023/0380505 A1
(43) Pub. Date: Nov. 30, 2023

(54) ELECTRONIC VAPORIZATION DEVICE AND VAPORIZER

(71) Applicant: Hainan Moore Brothers Technology Co., Ltd., Hainan (CN)

(72) Inventors: Lipeng YU, Hainan (CN); Xianglong ZENG, Hainan (CN); Jiyong YANG, Hainan (CN)

(21) Appl. No.: 18/319,328

(22) Filed: May 17, 2023

(30) Foreign Application Priority Data
May 31, 2022 (CN) 202210614660.3

(51) Int. Cl. A24F 40/485; H05B 1/02; A24F 40/10

(52) U.S. Cl. CPC A24F 40/485; H05B 1/0244; A24F 40/10; H05B 2203/021

(57) ABSTRACT

A vaporizer includes: a vaporization shell; a vaporization assembly; and a protective assembly. The vaporization shell includes a liquid storage cavity. The vaporization assembly is arranged in the vaporization shell and has a heating structure and a liquid flowing channel, the liquid flowing channel being in communication with the heating structure so as to allow a vaporizable liquid medium in the liquid storage cavity to be outputted to the heating structure. The protective assembly is linked with the vaporization shell, the protective assembly being driven by rotating the vaporization shell to regulate an amount of a flowing liquid outputted from the liquid storage cavity to the liquid flowing channel, an amount of air entering the vaporization assembly, and on/off of a circuit between the vaporization assembly and a power supply assembly of an electronic vaporization device.

### CROSS-REFERENCE TO PRIOR APPLICATION

Priority is claimed to Chinese Patent Application No. 202210614660.3, filed on May 31, 2022, the entire disclosure of which is hereby incorporated by reference herein.

### FIELD

The present invention relates to the field of vaporization, and more specifically, to an electronic vaporization device and a vaporizer.

### BACKGROUND

A vaporizable liquid medium of an electronic vaporization device in the related art is usually stored in a liquid storage cavity, and the vaporizable liquid medium is vaporized by a vaporization assembly to generate vaporized gas for a user to inhale. The electronic vaporization device with a larger capacity is prone to problems such as liquid leakage, power consumption of the battery core, an obvious difference in tastes of a section before and after inhalation, and the like during transportation, storage, and use.

### SUMMARY

In an embodiment, the present invention provides a vaporizer, comprising: a vaporization shell; a vaporization assembly; and a protective assembly, wherein the vaporization shell comprises a liquid storage cavity, wherein the vaporization assembly is arranged in the vaporization shell and comprises a heating structure and a liquid flowing channel, the liquid flowing channel being in communication with the heating structure so as to allow a vaporizable liquid medium in the liquid storage cavity to be outputted to the heating structure, and wherein the protective assembly is linked with the vaporization shell, the protective assembly being driven by rotating the vaporization shell to regulate an amount of a flowing liquid outputted from the liquid storage cavity to the liquid flowing channel, an amount of air entering the vaporization assembly, and on/off of a circuit between the vaporization assembly and a power supply assembly of an electronic vaporization device.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 is a schematic structural diagram of an electronic vaporization device according to a first embodiment of the present invention.

FIG. 2 is a schematic diagram of a state of the electronic vaporization device shown in FIG. 1 before or after use.

FIG. 3 is a schematic diagram of a state of the electronic vaporization device shown in FIG. 1 in use.

FIG. 4 is a schematic partial structural exploded view of a vaporizer of the electronic vaporization device shown in FIG. 1.

FIG. 5 is a schematic structural diagram of a vaporization shell of a vaporizer shown in FIG. 4.

FIG. 6 is a schematic structural diagram of a vaporization base in a vaporization assembly of the vaporizer shown in FIG. 4.

FIG. 7 is a schematic structural diagram of a liquid flowing control mechanism of a protective assembly of the electronic vaporization device shown in FIG. 4.

FIG. 8 is a schematic structural diagram of the liquid flowing control mechanism shown in FIG. 7 from another angle.

FIG. 9 is a schematic structural diagram of a conductive structure of the protective assembly of the electronic vaporization device shown in FIG. 4.

FIG. 10 is a schematic structural diagram of the conductive structure of the protective assembly of the electronic vaporization device shown in FIG. 9 from another angle.

FIG. 11 is a schematic structural diagram of a conductive member of the conductive structure shown in FIG. 9.

FIG. 12 is a schematic structural diagram of a support of the electronic vaporization device shown in FIG. 2.

FIG. 13 is a schematic diagram of a state of the electronic vaporization device shown in a second embodiment of the present invention before or after use.

FIG. 14 is a schematic diagram of a state of the electronic vaporization device shown in FIG. 13 in use.

FIG. 15 is a schematic structural diagram of an electronic vaporization device according to a third embodiment of the present invention.

FIG. 16 is a schematic diagram of a state of the electronic vaporization device shown in FIG. 15 before or after use.

FIG. 17 is a schematic structural diagram of the electronic vaporization device shown in FIG. 15 in use.

FIG. 18 is a schematic diagram of a state of the electronic vaporization device shown in FIG. 17 in use.

FIG. 19 is a schematic structural diagram of a vaporization shell of the electronic vaporization device shown in FIG. 18.

FIG. 20 is a schematic structural diagram of a conductive structure in the protective assembly of the electronic vaporization device shown in FIG. 19.

FIG. 21 is a schematic structural diagram of a battery shell of a power supply assembly of the electronic vaporization device shown in FIG. 19.

FIG. 22 is a schematic structural diagram of an electronic vaporization device shown in a fourth embodiment of the present invention before or after use.

FIG. 23 is a schematic diagram of a state of the electronic vaporization device shown in FIG. 22 before or after use.

FIG. 24 is a schematic structural diagram of the electronic vaporization device shown in FIG. 22 in use.

FIG. 25 is a schematic diagram of a state of the electronic vaporization device shown in FIG. 24 in use.

FIG. 26 is a schematic structural diagram of a movable member of a conductive structure of the electronic vaporization device shown in FIG. 25.

### DETAILED DESCRIPTION

In an embodiment, the present invention provides an improved vaporizer and an improved electronic vaporization device.

In an embodiment, the present invention provides a vaporizer, including a vaporization shell, a vaporization assembly, and a protective assembly.

The vaporization shell includes a liquid storage cavity.

The vaporization assembly is arranged in the vaporization shell and includes a heating structure and a liquid flowing channel. The liquid flowing channel is in communication with the heating structure to allow a vaporizable liquid medium in the liquid storage cavity to be outputted to the heating structure.

The protective assembly is linked with the vaporization shell, and the protective assembly is driven by rotating the vaporization shell to regulate an amount of a flowing liquid outputted from the liquid storage cavity to the liquid flowing channel, an amount of air entering the vaporization assembly, and on/off of a circuit between the vaporization assembly and a power supply assembly of an electronic vaporization device.

In some embodiments, the protective assembly includes a liquid flowing control mechanism. The liquid flowing control mechanism is arranged in the vaporization shell, and is driven by the rotation of the vaporization shell to regulate the liquid flowing amount of the liquid flowing channel.

In some embodiments, the liquid flowing control mechanism includes a turntable and a communication channel arranged on the turntable.

The turntable is arranged between the liquid storage cavity and the vaporization assembly and is driven into rotation by the rotation of the vaporization shell, so that the communication channel is at least partially in communication with the liquid flowing channel and the liquid storage cavity or completely misaligned with the liquid flowing channel.

In some embodiments, the vaporization assembly includes a vaporization base, and the liquid flowing control mechanism is rotatably arranged on the vaporization base.

The liquid flowing channel is arranged on the vaporization base.

In some embodiments, a limiting assembly is arranged on the liquid flowing control mechanism and the vaporization base, and configured to limit a rotation angle of the liquid flowing control mechanism.

The limiting assembly includes a limiting post and a limiting groove. The limiting post is arranged on the liquid flowing control mechanism, and the limiting groove is arranged on the vaporization base and is engaged with the limiting post.

In some embodiments, the limiting groove is in the shape of an arc, and the center of a circle of the arc is concentric with the center of a rotation trajectory of the liquid flowing control mechanism.

In some embodiments, a connecting positioning assembly is arranged between the vaporization shell and the liquid flowing control mechanism.

The connecting positioning assembly includes a connecting positioning post and a connecting positioning hole. The connecting positioning post is arranged on the inner side wall of the vaporization shell and extends in the axial direction of the vaporization shell. The positioning hole is arranged on the liquid flowing control mechanism and corresponding to the connecting positioning post, and configured to be engaged with the connecting positioning post.

In some embodiments, the vaporization shell includes an opening.

The protective assembly includes a conductive structure. The conductive structure is arranged close to the opening of the vaporization shell and is driven into rotation by the rotation of the vaporization shell, so that the vaporization assembly is electrically connected to or disconnected from the power supply assembly of the electronic vaporization device.

In some embodiments, the vaporization assembly includes a conductive component. The conductive structure includes a movable member and at least one conductive member. The movable member is linked with the vaporization shell. The at least one conductive member is arranged on the movable member, and the conductive member is driven by the rotation of the movable member to contact the conductive component and an electrode on the power supply assembly, so that the conductive component is electrically connected to the power supply assembly, or the conductive member is driven by the rotation of the movable member not to contact the conductive component and/or the electrode on the power supply assembly, so that the conductive component is disconnected from the power supply assembly.

In some embodiments, the movable member includes a disc body, the disc body is arranged coaxially with the vaporization shell, and the center of the disc body is located on the axis of the vaporization shell.

In some embodiments, a mounting limit assembly is arranged on the movable member and the vaporization shell.

The mounting limit assembly includes a limiting engagement groove and a limiting engagement protrusion. The limiting engagement groove is arranged on the side wall of the movable member, and the limiting engagement protrusion is arranged on the vaporization shell and extends away from the vaporization shell in the axial direction from the opening of the vaporization shell, and is arranged corresponding to the limiting engagement groove and configured to be engaged with the limiting engagement groove.

In some embodiments, the conductive member is an elastic sheet structure.

In some embodiments, the conductive member includes a first abutting portion configured to abut against the conductive component, a second abutting portion configured to abut against the electrode, and a connection portion configured to connect the first abutting portion to the second abutting portion.

In some embodiments, the first abutting portion is bent relative to the connection portion, and the first abutting portion is an arc-shaped structure protruding away from the movable member.

In some embodiments, two conductive members are arranged, and the first abutting portions of the two conductive members extend in opposite directions.

In some embodiments, two conductive members are arranged, and the first abutting portions of the two conductive members extend in the same direction.

In some embodiments, the protective assembly includes an air inlet control mechanism. The air inlet control mechanism includes a movable member and a communication airway, and the movable member is linked with the vaporization shell. The communication airway is arranged on the movable member. The vaporization shell during the rotation is driven into rotation by the movable member, so that external air enters the vaporization assembly or the external air is prevented from entering the vaporization assembly by the movable member.

In some embodiments, the communication airway includes an airflow through hole arranged on the movable member. In some embodiments, the airflow through hole is a waist-shaped hole.

The present invention further constructs an electronic vaporization device, including a power supply assembly and the vaporizer described in the present invention. The vaporizer is connected to the power supply assembly. The power supply assembly includes a support, and an air inlet hole in communication with the outside is arranged on the support.

The protective assembly of the vaporizer includes an air inlet control mechanism. The air inlet control mechanism includes a movable member and a communication airway arranged on the movable member, the movable member is linked with the vaporization shell, and when the movable member is driven into rotation by rotation of the vaporization shell, the communication airway is at least partially in communication with the air inlet hole or completely misaligned with the air inlet hole.

The implementation of the electronic vaporization device and the vaporizer of the present invention has the following beneficial effects. The vaporizer is provided with the protective assembly linked with the vaporization shell, and the vaporization shell is rotated to drive the protective assembly to regulate the amount of liquid outputted from the liquid storage cavity to the liquid flowing channel, the air amount of the vaporization assembly, and the on/off of the circuit between the vaporization assembly and the power supply assembly. The protective assembly of the vaporizer can prevent the vaporizable liquid medium from leaking, resolve the problem of self-consumption of the power supply assembly, and/or prevent accidental inhalation.

In order to provide a clearer understanding of the technical features, objectives, and effects of the present invention, specific implementations of the present invention are described in detail with reference to the accompanying drawings.

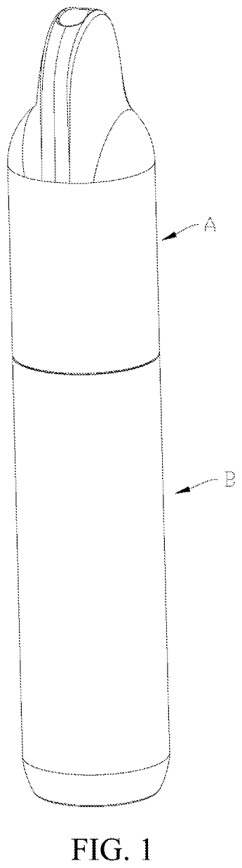

FIG. 1 to FIG. 3 show a first embodiment of an electronic vaporization device of the present invention. The electronic vaporization device may be configured to heat and vaporize a vaporizable liquid medium, so that the vaporizable liquid medium generates vaporized gas for a user to inhale. In some embodiments, the electronic vaporization device may be a disposable vaporization device. The electronic vaporization device may control on/off of a circuit, and can effectively solve the problem of self-consumption, reduce the imbalance of an oil-electricity ratio, have the function of preventing accidental inhalation, and have advantages of being less prone to liquid leakage, simple in structure, and good in vaporization taste.

As shown in FIG. 1 to FIG. 3, in this embodiment, the electronic vaporization device includes a vaporizer A and a power supply assembly B. The vaporizer A may be configured to vaporize a vaporization medium, and the power supply assembly B may be mechanically and electrically connected to the vaporizer A, and may be configured to supply power to the vaporizer A.

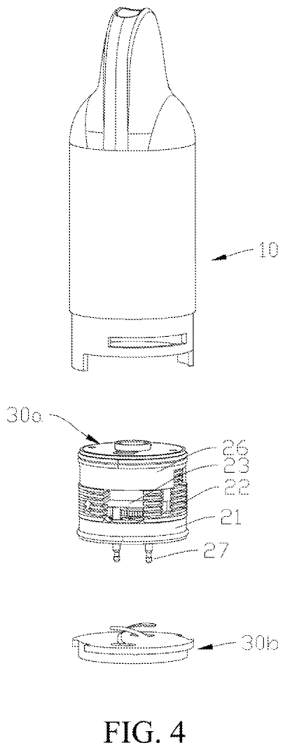

As shown in FIG. 4, in this embodiment, the vaporizer A includes a vaporization shell and a vaporization assembly 20. The vaporization shell 10 may be cylindrical, and has a hollow structure inside that may be configured to accommodate the vaporization assembly 20 and store the vaporizable liquid medium. The vaporization assembly 20 may be accommodated in the vaporization shell 10 and configured to heat and vaporize the vaporizable liquid medium. In this embodiment, the vaporizer A further includes a protective assembly 30. The protective assembly may be linked with the vaporization shell 10. When the vaporization shell 10 is rotated, the protective assembly 30 may be driven into rotation, thereby driving the protective assembly 30 to regulate a liquid flowing amount and an air inflow and control on/off of a circuit between the vaporization assembly 20 and the power supply assembly B.

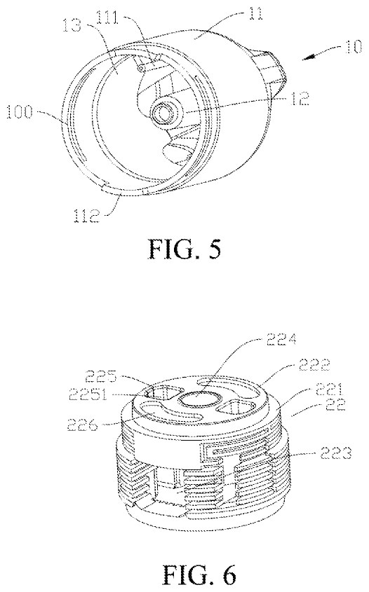

As shown in FIG. 5, in this embodiment, the vaporization shell 10 includes a housing 11 and an air outlet tube 12 arranged in the housing 11. The air outlet tube 12 may be located at a central axis of the housing 11, and a gap between the air outlet tube and an inner side wall of the housing 11 may form a liquid storage cavity 13 for storing the vaporizable liquid medium. The vaporization shell 10 further includes an opening 100. The opening 100 may be arranged at one end of the vaporization shell 10, and is in communication with the liquid storage cavity 13 for the vaporization assembly 20 to be mounted in the housing 11.

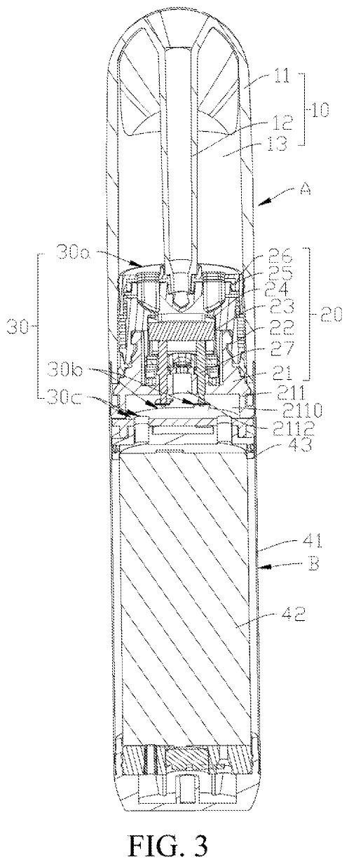

As shown in FIG. 3 and FIG. 4 again, in this embodiment, the vaporization assembly includes a vaporization base 21, a vaporization base 22, and a heating structure 23. The vaporization base 21 may be configured to support the heating structure 23. In some other embodiments, the vaporization base 21 may be omitted. The vaporization base 22 is sleeved on the vaporization base 21 and detachably assembled with the vaporization base 21. The heating structure 23 is accommodated in the vaporization base 21, and is configured to heat the vaporizable liquid medium transmitted from the liquid storage cavity 13.

In this embodiment, the vaporization base 21 may include a base body 211 and an engagement structure 212. The base body 211 may be stuffed into the vaporization shell 10 to block an opening at a lower part of the vaporization shell 10. The engagement structure 212 may be arranged on the base body 211 and may extend into the vaporization base 22 to be engaged with the vaporization base 22. A chamber 2110 may be arranged on a side of the base body 211 away from the engagement structure 212. The chamber 2110 may be configured to temporarily store gas or form an airflow channel. An air inlet post 2112 may be arranged on the base body 211. The air inlet post 2112 is in communication with the chamber 2110, and is used for gas to enter the vaporization base 22, so that the vaporized gas formed by vaporization can be taken out.

As shown in FIG. 6, in this embodiment, the vaporization base 22 includes a body 221 and an engagement protrusion 222. The body 221 may be cylindrical and has a hollow structure provided with an opening at one end. A vaporization cavity 223 may be formed on the inner side of the body 221. The vaporization cavity 223 may be configured to accommodate the heating structure 23 and provide a vaporization space for the heating structure 23. In this embodiment, the engagement protrusion 222 protrudes from one end of the body 221. The cross-sectional size of the engagement protrusion may be less than the cross-sectional size of the body 221, and the engagement protrusion may be engaged with a first seal structure 25. In this embodiment, the vaporization base 22 further includes a vaporization hole 224. The vaporization hole 224 may be in communication with the vaporization cavity 223, and is used for the vaporized gas formed by the vaporization of the heating structure 23 to be outputted. In this embodiment, the vaporization hole 224 is arranged at a central axis of the body 221. In this embodiment, the vaporization base 22 further includes a liquid flowing hole 225. Two liquid flowing holes 225 may be provided. The two liquid flowing holes 225 may be arranged on two opposite sides of the vaporization hole 224. The liquid flowing holes 225 may be arranged in an axial direction of the vaporization base 22, and a liquid flowing channel 2251 may be formed on the inner side of the liquid flowing holes. The liquid flowing channel 2251 may be used for the vaporizable liquid medium in the liquid storage cavity 13 to be outputted to the heating structure 23.

In this embodiment, the heating structure 23 may include a porous body and a heating element arranged on the porous body. The porous body may be a ceramic porous body. Certainly, it may be understood that, in some other embodiments, the porous body may not be limited to the ceramic porous body. The porous body further includes a heating surface, and the heating element may be arranged on the heating surface. The heating element may be a heating wire or a heating film. Certainly, it may be understood that, in some other embodiments, the heating element may not be limited to the heating wire or the heating film.

In this embodiment, the vaporization assembly 20 further includes a cover 24. The cover 24 may cover a part of the heating structure 23 and may be mounted in the vaporization base 22 together with the heating structure 23. The cover 24 may be a silicone member, which can function to fix the heating structure 23. In some embodiments, the cover 24 may be omitted.

In this embodiment, the vaporization assembly 20 further includes the first seal structure 25. The first seal structure 25 may be sleeved on the engagement protrusion 22. The first seal structure 25 may be a silicone sleeve, and may be configured to seal a gap between the liquid flowing control mechanism 30a of the protective assembly 30 and the engagement protrusion 22. Vias corresponding to the vaporization hole 224 and the liquid flowing hole 225 may be arranged on the first seal structure 25. It may be understood that, in some other embodiments, the first seal structure 25 may not be limited to the silicone sleeve.

In this embodiment, the vaporization assembly 20 further includes a second seal structure 26. The second seal structure 26 may be sleeved on the body 221, and located on the periphery of the first seal structure 25. In some embodiments, the second seal structure 26 may be an annular silicone sleeve, and may be configured to seal a gap between the vaporization base 22 and the vaporization shell 10. Certainly, it may be understood that, in some other embodiments, the second seal structure 26 may not be limited to the silicone sleeve.

In this embodiment, the vaporization assembly 20 further includes a conductive component 27. The conductive component 27 may be a conductive post. Two conductive posts may be arranged. One end of each of the two conductive posts may be connected to the heating structure 23. Specifically, the end may be connected to the heating element, and an other end may pass out of the vaporization base 21 and may be connected to the power supply assembly B through the protective assembly 30.

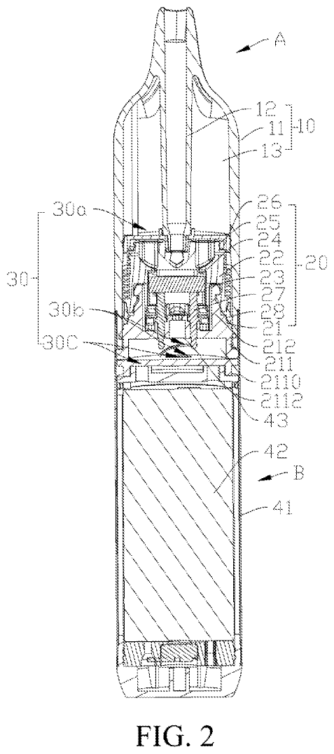

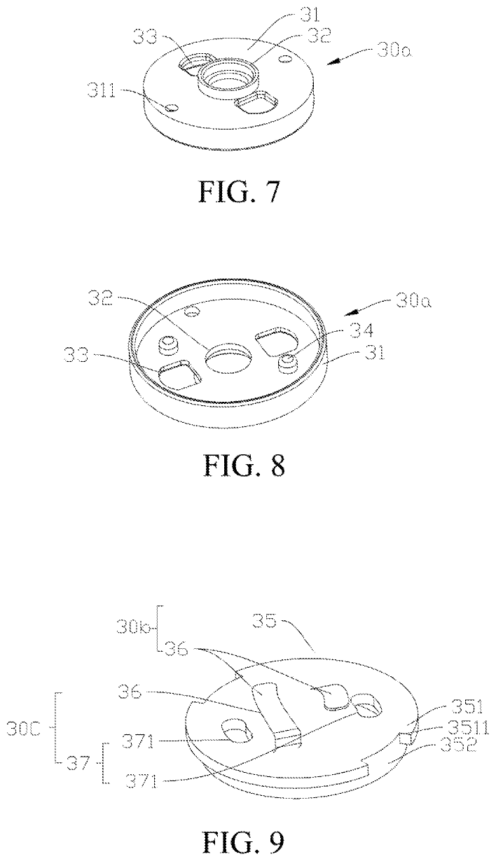

As shown in FIG. 2, FIG. 4, and FIG. 7 to FIG. 8, in this embodiment, the protective assembly 30 may include a liquid flowing control mechanism 30a. The liquid flowing control mechanism 30a may be arranged in the vaporization shell 10, and may be arranged coaxially with the vaporization shell 10 and connected to the vaporization shell 10. The vaporization shell 10 is rotated to drive the liquid flowing control mechanism 30a to rotate, and then the amount of a flowing liquid outputted from the liquid storage cavity 13 to the liquid flowing holes 2251 can be regulated. Specifically, the liquid flowing control mechanism 30a is rotatably arranged on the vaporization base 22. Specifically, the liquid flowing control mechanism may be arranged on the first seal structure 25. The liquid flowing control mechanism is arranged in the second seal structure 26, that is to say, the side surface of the liquid flowing control mechanism 30a may be sealed by the second seal structure 26, so that the vaporizable liquid medium will not flow out during and after the rotation. In addition, during the rotation, the vaporizable liquid medium between the second seal structure 26 and the liquid flowing control mechanism 30a and the vaporizable liquid medium between the first seal structure 25 and the liquid flowing control mechanism 30a can play the role of lubrication, thereby reducing the friction during the rotation. By arranging the liquid flowing control mechanism 30a, the liquid storage cavity 13 may be isolated from the liquid flowing channel 2251 during transportation, storage, and use of the electronic vaporization device, so that liquid leakage can be prevented to avoid the self-starting phenomenon or damage to a circuit board.

In this embodiment, the liquid flowing control mechanism 30a includes a turntable 31, a central through hole 32, and a communication channel 33. In this embodiment, the turntable 31 may be arranged between the liquid storage cavity 13 and the vaporization assembly 20, and arranged coaxially with the vaporization shell 10. A center of the turntable 31 may be located on the axis of the vaporization shell 10. Specifically, the turntable 31 is sleeved on the first seal structure 25 and is connected to the vaporization shell 10, and may further be linked with the vaporization shell 10. In some embodiments, the turntable 31 may be in the shape of a disk. Certainly, it may be understood that in some other embodiments, the turntable 31 may not be limited to being in the shape of the disk. In some embodiments, the central through hole 32 may be located at a central axis of the turntable 31, and extends through the turntable 31 in a thickness direction. In this embodiment, the central through hole 32 may be arranged corresponding to the vaporization hole 224 and in communication with the vaporization hole 224 and the air outlet tube 12. In this embodiment, the communication channel 33 is arranged on the turntable 31 and may be respectively arranged on two opposite sides of the central through hole 32, and the communication channels 33 may be linked with the vaporization shell 10. In some embodiments, the connection channel 33 may be a through hole. Two through holes may be provided. The two through holes may be arranged in a one-to-one correspondence with the two liquid flowing holes 225. In some embodiments, the through hole may be a round hole or a square hole. When in use, the vaporization shell 10 may be rotated to drive the turntable 31 to rotate, so that the communication channel 33 can be at least partially in communication with the liquid flowing channel 2251 and the liquid storage cavity 13, and the vaporizable liquid medium in the liquid storage cavity 13 can be conveniently outputted to the liquid flowing channel 2251. In addition, the overlapping area of the through hole and the liquid flowing hole 25 may be regulated through rotation, so that the amount of the flowing liquid outputted from the liquid storage cavity 13 to the liquid flowing channel 2251 can be regulated. When not in use, the vaporization shell 10 may be rotated so that the communication channel 33 and the liquid flowing channel 2251 are completely misaligned, and then the liquid flowing channel 2251 is isolated from the liquid storage cavity 13, thereby preventing the vaporizable liquid medium in the liquid storage cavity 13 from leaking out from the liquid flowing channel 2251.

As shown in FIG. 5, FIG. 7, and FIG. 8, in this embodiment, a limiting assembly is arranged on the liquid flowing control mechanism 30a and the vaporization base 22. The limiting assembly is configured to limit a rotation angle of the liquid flowing control mechanism 30a, thereby limiting the maximum opening degree and the minimum opening degree of the liquid flowing hole 25. In this embodiment, the angle of rotation of the liquid flowing control mechanism 30a may be 70 degrees. It may be understood that in some other embodiments, the angle of rotation of the liquid flowing control mechanism 30a may not be limited to 70 degrees. In this embodiment, the limiting assembly includes a limiting post 34 and a limiting groove 226. The limiting post 34 is arranged on the liquid flowing control mechanism 30a. Specifically, the limiting post 34 may be arranged on a side of the turntable 31 opposite to the first seal structure 25, and protrudes from the turntable 31. In this embodiment, two limiting posts 34 may be arranged. The two limiting posts 34 may be located on two opposite sides of the central through hole 32. The limiting groove 226 may be arranged on the vaporization base 22. Specifically, the limiting grooves 226 may be formed on a protruding end surface of the engagement protrusion 222 and arranged in a one-to-one correspondence with the limiting posts 34, and may be engaged with the limiting post 34 for limiting. In some embodiments, the limiting groove 226 may be in the shape of an arc. A center of a circle of the arc may be concentric with a center of a rotation trajectory of the liquid flowing control mechanism 30a. That is to say, a center of a circle of the limiting groove 226 coincides with a center of a circle of the turntable 31. If the length of the limiting groove 226 is less than the circumference of the turntable 31, two extreme positions may be formed at both ends of the limiting groove 226. In some embodiments, when the liquid flowing control mechanism 30a is assembled with the vaporization base 22, the limiting post 34 may be inserted into the limiting groove 226 through the first seal structure 25. When the vaporization shell 10 is rotated, the limiting post 34 slides to one end of the limiting groove 226, that is, the turntable 31 rotates to a first limit position. In this case, the liquid flowing hole 25 has the maximum opening degree. When the limiting post 34 slides to an other end of the limiting groove 226, that is, the turntable 31 rotates to a second limit position, the liquid flowing hole 25 may be completely closed at this time, and the vaporizable liquid medium in the liquid storage cavity 13 cannot be outputted to the liquid flowing hole 25.

In this embodiment, a connecting positioning assembly is arranged between the vaporization shell 10 and the liquid flowing control mechanism 30a, and the connecting positioning assembly is configured to connect the vaporization shell 10 and the liquid flowing control mechanism 30a. In this embodiment, the connecting positioning assembly includes a connecting positioning post 111 and a positioning hole 311. The connecting positioning post 111 may be arranged on an inner side wall of the vaporization shell 10 and extend in an axial direction of the vaporization shell 10. Specifically, in this embodiment, the connecting positioning post 111 may be arranged on the inner side wall of the housing 11 and extend in an axial direction of the housing 11. A set distance is left between the connecting positioning post 111 and the opening 110. That is to say, the length of the connecting positioning post 111 is less than the length of the housing 11. In some embodiments, two connecting positioning posts 111 may be arranged. The two connecting positioning posts 111 are located on two opposite sides of the air outlet tube 12. The positioning hole 311 may be arranged on the liquid flowing control mechanism 30a. Specifically, the positioning hole may be arranged on the turntable 31. Two positioning holes may be arranged. The two positioning holes 311 may be located on two opposite sides of the central through hole 32. The positioning holes 311 are arranged in a one-to-one correspondence with the connecting positioning posts 111. When the liquid flowing control mechanism 30a is assembled with the vaporization shell 10, the connecting positioning post 111 may be inserted into the through hole 311 and engaged with the through hole 311, thereby connecting the liquid flowing control mechanism 30a to the vaporization shell 10, and facilitating the linkage between the liquid flowing control mechanism 30a and the vaporization shell 10.

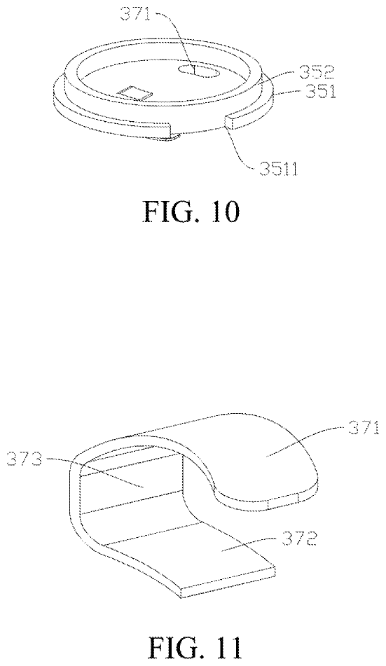

As shown in FIG. 2, FIG. 4, FIG. 9, and FIG. 10, in this embodiment, the protective assembly 30 further includes a conductive structure 30b. The conductive structure 30b may be arranged for an end of the vaporization shell 10. Specifically, the conductive structure 30b may be arranged close to the opening 100 of the vaporization shell 10, and connected to the vaporization shell 10, and may be linked with the vaporization shell 10. When the vaporization shell 10 is rotated, the conductive structure 30b may be driven into rotation, so that the vaporization assembly can be electrically connected to or disconnected from the power supply assembly B. That is to say, the on-off of the circuit between the vaporization assembly 20 and the power supply assembly B can be regulated, thereby solving the problem of self-consumption of the power supply assembly B and reducing the imbalance of the vaporizable liquid medium and the electric energy ratio.

As shown in FIG. 9 to FIG. 11, in this embodiment, the conductive structure 30b includes a movable member 35 and two conductive members 36. The movable member 35 may be arranged on a side of the vaporization base 21 opposite to the vaporization shell 10, connected to the vaporization shell 10, and then linked with the vaporization shell 10. The conductive members 36 are arranged on the movable member 35, and in a one-to-one correspondence with the two conductive components 27. When the vaporization shell 10 rotates, the movable member may be driven into rotation, and then the conductive members 36 are driven to contact the conductive components 27 and the electrode on the power supply assembly B, thereby realizing the conductive connection between the conductive component 27 and the power supply assembly B. Alternatively, the movable member 35 rotates to drive the conductive member 36 not to contact the conductive components 27 and the electrode on the power supply assembly B, thereby disconnecting the conductive components 27 from the power supply assembly B. In some other embodiments, the conductive member may also be misaligned with only the conductive component 27, or does not contact only the electrode on the power supply assembly B. It may be understood that in some embodiments, the number of the conductive members 36 may be not limited to two, and in some embodiments, one conductive member 36 may also be arranged.

Specifically, in this embodiment, the movable member 35 includes a disc body 351 and a sleeve portion 352. The disc body 351 is rotatably arranged at the end of the vaporization base 21 opposite to the vaporization shell 10 and arranged coaxially with the vaporization shell 10, and a center of the disc body 251 may be located on the axis of the vaporization shell 10. The sleeve portion 352 is arranged on the side of the disc body 351 opposite to the vaporization base 21, which may be cylindrical and may be sleeved on the support 43 of the power supply assembly B.

In this embodiment, a mounting limit assembly is arranged on the movable member 35 and the vaporization shell 10. Specifically, the mounting limit assembly includes a limiting engagement groove 3511 and a limiting engagement protrusion 112. The limiting engagement groove 3511 is arranged on a side wall of the disc body 351. In this embodiment, two limiting engagement grooves 3511 may be arranged. The two limiting engagement grooves 3511 may be arranged on two opposite sides of the disc body 351. The limiting engagement protrusion 112 is arranged on the vaporization shell 10 and extends away from the vaporization shell 10 in the axial direction from the opening 100 of the vaporization shell 10, and is arranged in a one-to-one correspondence with the limiting engagement groove 3511. During assembly, the limiting engagement protrusion 112 may be engaged with the limiting engagement groove 3511 and mated with the limiting engagement groove 3511.

In this embodiment, the conductive member 36 may extend through the disc body 351 in the thickness direction. The two conductive members 36 may be arranged side by side, and may be integrally formed with the disc body 351 by injection molding. In this embodiment, the conductive member 36 is an elastic sheet structure. Specifically, the conductive member 36 may be a copper sheet. By arranging the conductive member 36 into an elastic piece structure, the connection between the conductive member 36 and the conductive component 27 is more reliable and the friction force is smaller during the rotation. In addition, it is convenient to realize the automatic design and reduce the wire bonding process. Certainly, it may be understood that, in some other embodiments, the conductive member 36 may not be limited to the copper sheet. In some other embodiments, the conductive member 36 is not limited to the sheet structure either.

Further, in this embodiment, the conductive member 36 may include a first abutting portion 361, a second abutting portion 362, and a connection portion 363. In this embodiment, the first abutting portion 361 may be configured to abut against the conductive component 27, and may pass out of the disc body 351, and in this embodiment, the first abutting portion 361 may be an arc-shaped structure protruding away from the movable member 35. In this embodiment, the first abutting portion 361 may have an end connected to the connection portion 363 and may be bent relative to the connection portion 363. In this embodiment, the second abutting portion 362 may be configured to abut against the electrode on the power supply assembly B. The second abutting portion may be a flat sheet structure and may be attached to a bottom surface of the movable member 35. Specifically, the second abutting portion 362 may be attached to a bottom surface of the disc body 351. The second abutting portion 362 may have an end connected to the connection portion 363 and may be bent relative to the connection portion 363. The connection portion 363 may extend through the disc body 351, and two ends of the connection portion may be respectively connected to the first abutting portion 361 and the second abutting portion 362. In this embodiment, the first abutting portions 361 of the two conductive members 36 extend in opposite directions. Certainly, it may be understood that, in some other embodiments, the first abutting portions 361 of the two conductive members 36 may extend in the same direction.

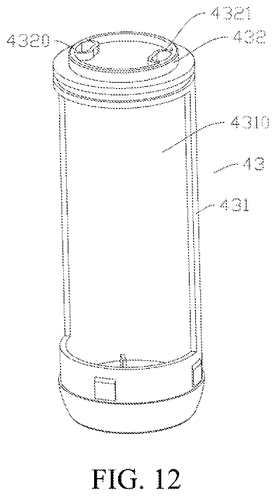

As shown in FIG. 2, FIG. 4, FIG. 9, FIG. 10, and FIG. 12, further, in this embodiment, the protective assembly 30 further includes an air inlet control mechanism 30c. The air inlet control mechanism 30c may be integrated with the conductive structure 30b. In this embodiment, the air inlet control mechanism 30c may include the movable member 35 and a communication airway 37, and the movable member 35 is the same as the movable member 35 of the conductive structure 30b. The details are not described herein again. The communication airway 37 is arranged on the movable member 35. When the vaporization shell 10 rotates, the movable member 35 rotates and may drive the communication airway 37 to rotate, so that external air can enter the vaporization assembly 20, or the external air is prevented from entering the vaporization assembly 20 by the movable member 35, thereby regulating the air inflow of the vaporization assembly 20. In this embodiment, two communication airways 37 may be arranged. The two communication airways 37 may be arranged on two opposite sides of the conductive members 36. The communication airways 37 each includes an airflow through hole 371. The airflow through hole 371 is arranged on the movable member 35 and extends through the movable member 35 in the thickness direction. In this embodiment, the airflow through hole 371 may be a waist-shaped hole. By arranging the airflow through hole 371 as the waist-shaped hole, the disc body 351 can be conveniently rotated, so that the coverage area of the airflow through hole 371 and the air inlet hole 4321 on the support 43 of the power supply assembly B can be changed, and the amount of air entering the vaporization assembly 20 can be conveniently regulated. Certainly, it may be understood that, in some other embodiments, the airflow through hole 371 may not be limited to the waist-shaped hole.

Further, in this embodiment, the power supply assembly B may include a battery shell 41, a battery 42, and a support 43. The battery shell 41 may be cylindrical, and is provided with an assembly opening at an end for a part of the vaporizer A to be inserted. In this embodiment, the air inlet control mechanism 30c may be arranged in the battery shell 41. Specifically, the movable member 35 may be arranged in the battery shell 41 and is in interference fit with the battery shell 41. The battery 42 may be accommodated on the support 43, and has two electrodes. The two electrodes may be electrically connected to the conductive component 27 of the vaporization assembly 20 through the conductive structure 30b. In this embodiment, the support 43 may be accommodated in the battery shell 41 and is configured to support the battery 42.

In this embodiment, the support 43 may include a support body 431 and a boss 432. An accommodating groove 4310 is formed in the inner side of the support body 431, and the accommodating groove 4310 may be configured to accommodate the battery 42. The boss 432 is arranged on an end of the support body 431. Specifically, the boss 432 is arranged on an end of the support body 431 opposite to the vaporization base 21. The sleeve portion 352 of the movable member 35 may be sleeved on the boss 432, and may be mated with the sleeve portion 352. That is to say, the connection structure between the movable member 35 and the support 43 is simple, and the friction can be reduced through mating of end surfaces. In this embodiment, an end surface 4320 is arranged on the boss 432. A gap is left between the disc body 351 and the end surface 4320, and the height of the gap is less than or equal to 0.05 mm. Alternatively, in this embodiment, the height of the gap may be 0.05 mm, so as to achieve a large inhalation resistance and prevent inhalation. In this embodiment, an air inlet hole 4321 may be arranged on the support 30, and two air inlet holes 4321 may be arranged. The two air inlet holes 4321 may be arranged on the boss 432 at intervals and symmetrically in a radial direction of the boss 432. The two airflow through holes 371 may be arranged in a one-to-one correspondence with the two communication airways 37. The movable member 35 may be driven into rotation during the rotation of the vaporization shell 10, so that the communication airway 37 can be at least partially in communication with the air inlet hole 4321, or misaligned with the air inlet hole 4321. That is to say, the air inlet hole 4321 may be blocked by the disc body 351. The air inlet control mechanism 30c may serve as an airway switch. When the electronic vaporization device is in use, the air inlet hole 4321 may be opened by rotating the vaporization shell 10, and when not in use, the air inlet hole 4321 may be closed by rotating the vaporization shell 10, thereby preventing accidental inhalation, preventing condensate from entering the support 43, and reducing the risk of the condensate damaging a mainboard arranged on the support 43.

As shown in FIG. 1 to FIG. 2 again, when the electronic vaporization device is not used (that is, before or after use), the vaporization shell 10 is rotated in a first direction, and the communication channel 33 is misaligned with the liquid flowing hole 225. That is to say, the liquid flowing hole 225 is completely blocked by the turntable 31. In this case, the vaporizable liquid medium in the liquid storage cavity 13 cannot flow into the heating structure 23 from the liquid flowing hole 225. The conductive members 36 are misaligned with (do not contact) the conductive components 27, that is, the circuit between the vaporization assembly 20 and the power supply assembly B is in a disconnected state, so that the power consumption of the power supply assembly B can be greatly reduced. The communication airway 37 may be misaligned with the air inlet hole 4321, that is, the air inlet hole 4321 is completely blocked by the disc body 351, so that the air cannot enter the air inlet post 2112 from the communication airway 37. That is to say, the air cannot enter the vaporization assembly 20, thereby preventing the accidental inhalation.

As shown in FIG. 3 to FIG. 4 again, when the electronic vaporization device is in use, the vaporization shell 10 is rotated in a second direction, and during the rotation, the conductive members 36 both contact the conductive components 27, that is, the circuit between the vaporization assembly 20 and the power supply assembly B is in a connected state. In the process of rotation until the conductive members 36 both contact the conductive components 27, the communication channel 33 is partially in communication with the liquid flowing hole 225. In this case, the vaporizable liquid medium in the liquid storage cavity 13 can flow into the heating structure 23 from the liquid flowing hole 225. The communication airway 37 may be partially in communication with the air inlet hole 4321, that is, external air may enter from the air inlet hole 4321, then enter the chamber 2111 of the vaporization base 21 through the communication airway 37, and then enter the vaporization cavity 23 from the air inlet post 2112. When the conductive members 36 both completely contact and are in communication with the conductive components 27, the vaporization shell 10 may be continuously rotated in the second direction, so that the communication channel 33 is completely in communication with the liquid flowing hole 225. The communication airway 37 may be completely in communication with the air inlet hole 4321. Certainly, in some other embodiments, the vaporization shell 10 is rotated to the set position in the second direction, so that the conductive members 36 may also both contact the conductive components 27, and the communication channels 33 are completely in communication with both the liquid flowing holes 225. The communication airway 37 may be completely in communication with both the air inlet holes 4321.

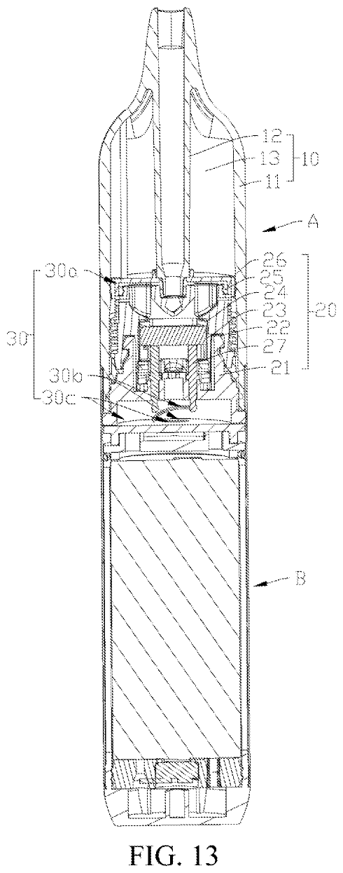

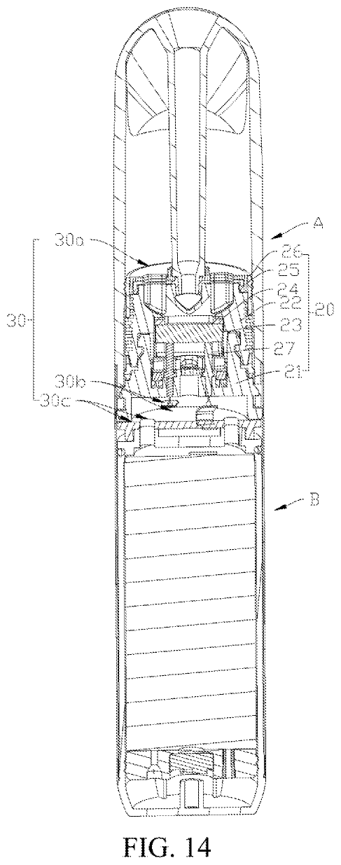

FIG. 13 to FIG. 14 show a second embodiment of an electronic vaporization device of the present invention, which is different from the first embodiment in that the conductive structure may be arranged in the power supply assembly B. Specifically, the conductive structure may be rotatably arranged in the battery shell 41, the sleeve portion 352 may be omitted, and the disc body 351 may be directly arranged on the end surface 4320 of the boss 432 of the support 43 to rotate. In this embodiment, the disc body 351 may be arranged coaxially with the power supply assembly B. Specifically, the disc body 351 may be arranged coaxially with the boss 432, and a center of the disc body 351 may be located on the axis of the boss 432.

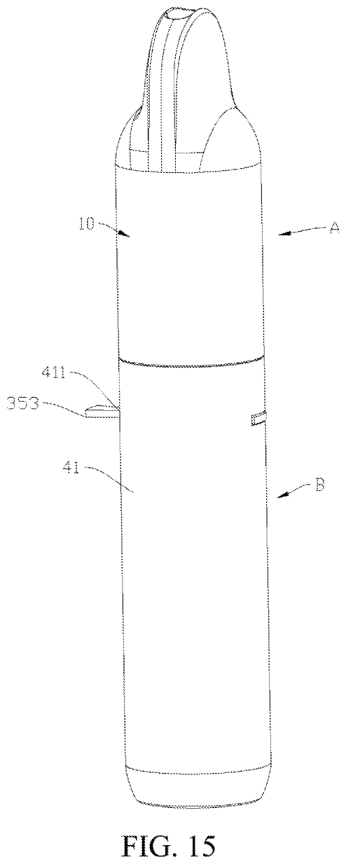

FIG. 15 to FIG. 18 show a third embodiment of an electronic vaporization device of the present invention, which is different from the first embodiment in that the conductive structure may not be linked with the vaporization shell 10, and the on/off of the circuit between the vaporization assembly 20 and the power supply assembly B is not realized only through rotation. The conductive structure 30 may be designed by radial sliding. In this embodiment, the vaporization assembly 20 may include a radial direction, and the disc body 351 may be slidably arranged in the radial direction of the vaporization assembly 20. It may be understood that, in some other embodiments, the conductive structure 30 may not only slide in the radial direction of the vaporization assembly 20, but may also be arranged in the battery shell 41 to slide in the radial direction of the power supply assembly B.

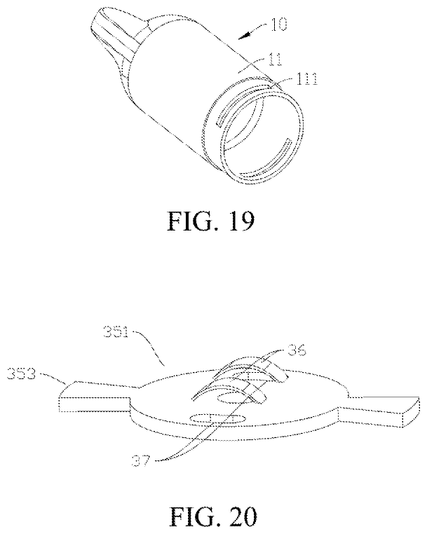

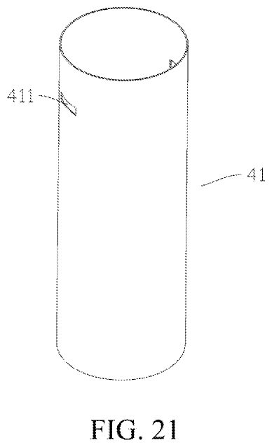

As shown in FIG. 19, in this embodiment, the limiting engagement protrusion 112 on the vaporization shell 10 may be omitted. As shown in FIG. 20 and FIG. 21, in this embodiment, a handle 353 may be arranged on the disc body 351. Two handles 353 may be arranged. The two handles 353 may be arranged on two opposite sides of the disc body 351, and may pass out of the battery shell 41. The handle 353 may be integrally formed with the disc body 351 for a user to push the disc body 351 to slide in the radial direction. In this embodiment, a first through hole 111 may be arranged on the vaporization shell 10, and the first through hole 111 may be used for the handle 353 to pass out. In this embodiment, a second through hole 411 may be arranged on the battery shell 41, and the second through hole 411 may be arranged in a one-to-one correspondence with the two handles 353 for the handles 353 to pass out.

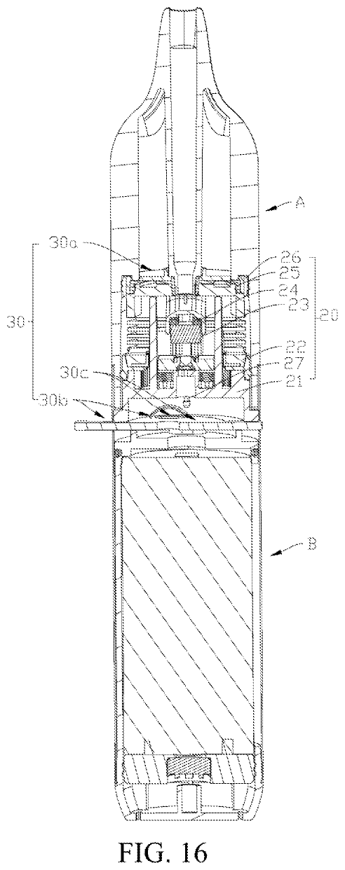

As shown in FIG. 15 to FIG. 16 again, when not in use (that is, before or after use), one of the handles 353 may be pushed, so that a length by which the one handle 353 passes out of the second through hole 411 is greater than a length by which the other handle 353 passes out of the second through hole 411, thereby causing the conductive member 36 to be misaligned with (not to contact) the conductive component 27, and then turning off the circuit between the vaporization assembly 20 and the power supply assembly B.

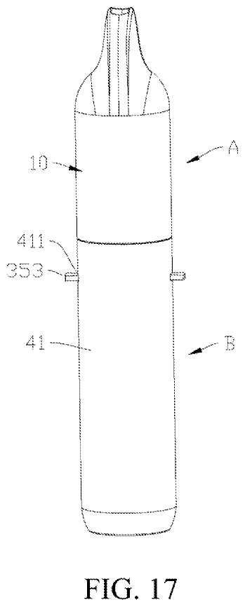

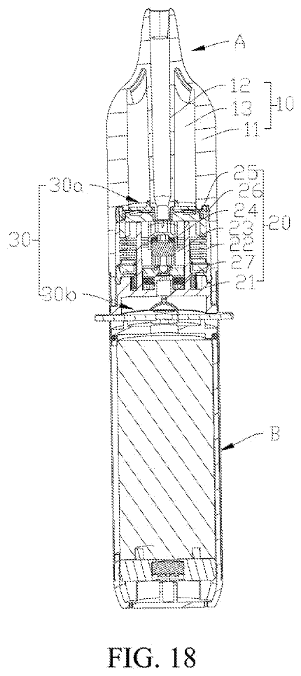

As shown in FIG. 17 to FIG. 18 again, when in use, one of the handles 353 may be pushed, so that the lengths by which the two handles 353 pass out of the second through hole 411 are equivalent, thereby causing the conductive member 36 to contact the conductive component 27, and then turning on the circuit between the vaporization assembly 20 and the power supply assembly B.

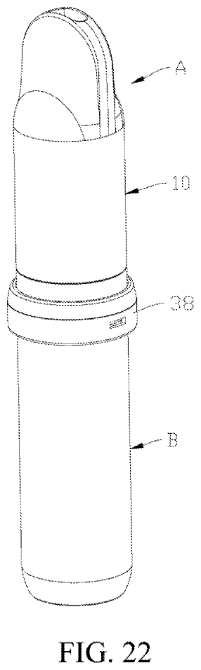

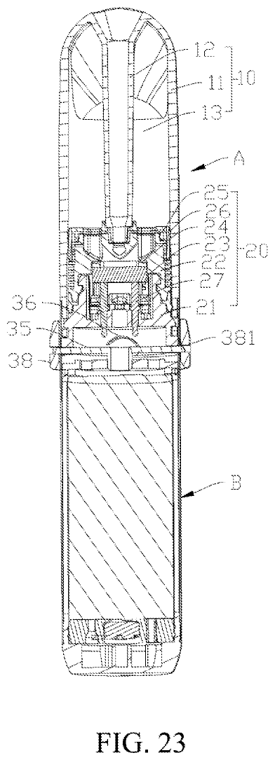

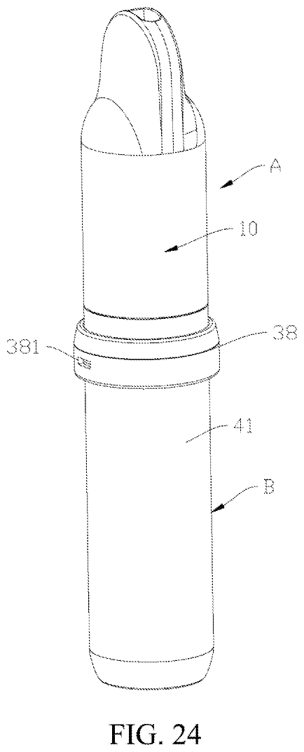

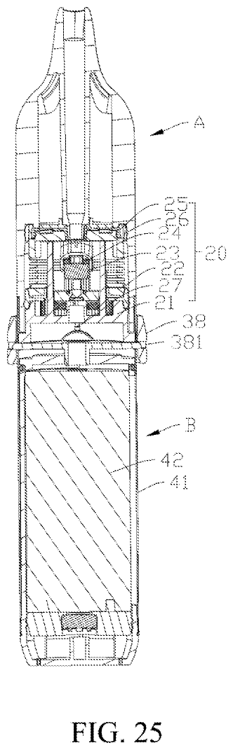

FIG. 22 to FIG. 25 show a fourth embodiment of an electronic vaporization device of the present invention, which is different from the third embodiment in that the conductive structure 25 may not be limited to radial sliding, and the conductive structure 25 may slide in the axial direction of the vaporization assembly 20 or the axial direction of the power supply assembly B.

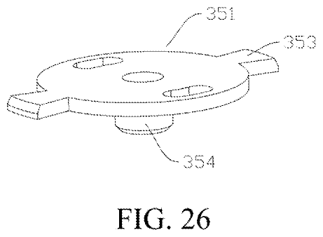

As shown in FIG. 26, in this embodiment, a limiting portion 354 may be arranged on the disc body 351. The limiting portion 354 may be cylindrical and has a hollow structure. The limiting portion may be inserted into an end wall of the support body 431 from the boss 432, and is in interference fit with the end wall of the support body 431 to limit the axial sliding of the disc body 351 and prevent the disc body 351 from moving in the radial direction.

As shown in FIG. 22 to FIG. 25 again, in this embodiment, the conductive structure further includes a slider 38. The slider 38 is slidably sleeved on the battery shell 41 and connected to the handle 353. Specifically, the slider may be provided with a hole 381 for the handle 353 to be inserted and fixed, thereby realizing the engagement with the handle 353. The handle 353 may be driven to slide in the axial direction by sliding the slider 38 in the axial direction.

When not in use, the slider 38 may be slid toward the end away from the vaporizer A, thereby causing the conductive member 36 not to contact the conductive component 27, and then turning off the circuit between the vaporization assembly 20 and the power supply assembly B.

When in use, the slider 38 may be slid toward an end where the vaporizer A is inserted, thereby causing the conductive member 36 to contact the conductive component 27, and turning on the circuit between the vaporization assembly 20 and the power supply assembly B.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

What is claimed is:

1. A vaporizer, comprising:
a vaporization shell;
a vaporization assembly; and
a protective assembly,
wherein the vaporization shell comprises a liquid storage cavity,
wherein the vaporization assembly is arranged in the vaporization shell and comprises a heating structure and a liquid flowing channel, the liquid flowing channel being in communication with the heating structure so as to allow a vaporizable liquid medium in the liquid storage cavity to be outputted to the heating structure, and
wherein the protective assembly is linked with the vaporization shell, the protective assembly being driven by rotating the vaporization shell to regulate an amount of a flowing liquid outputted from the liquid storage cavity to the liquid flowing channel, an amount of air entering the vaporization assembly, and on/off of a circuit between the vaporization assembly and a power supply assembly of an electronic vaporization device.

2. The vaporizer of claim 1, wherein the protective assembly comprises a liquid flowing control mechanism, and
wherein the liquid flowing control mechanism is arranged in the vaporization shell and is driven into rotation by the rotation of the vaporization shell so as to regulate the liquid flowing amount of the liquid flowing channel.

3. The vaporizer of claim 2, wherein the liquid flowing control mechanism comprises a turntable and a communication channel arranged on the turntable, and
wherein the turntable is arranged between the liquid storage cavity and the vaporization assembly and is driven into rotation by the rotation of the vaporization shell so that the communication channel is at least partially in communication with the liquid flowing channel and the liquid storage cavity or completely misaligned with the liquid flowing channel.

4. The vaporizer of claim 1, wherein the vaporization assembly comprises a vaporization base, the liquid flowing control mechanism being rotatably arranged on the vaporization base, and
wherein the liquid flowing channel is arranged on the vaporization base.

5. The vaporizer of claim 4, wherein a limiting assembly is arranged on the liquid flowing control mechanism and the vaporization base, and is configured to limit a rotation angle of the liquid flowing control mechanism, and
wherein the limiting assembly comprises a limiting post and a limiting groove, the limiting post being arranged on the liquid flowing control mechanism, the limiting groove being arranged on the vaporization base and engaged with the limiting post.

6. The vaporizer of claim 5, wherein the limiting groove is in a shape of an arc, and a center of a circle of the arc is concentric with a center of a rotation trajectory of the liquid flowing control mechanism.

7. The vaporizer of claim 2, wherein a connecting positioning assembly is arranged between the vaporization shell and the liquid flowing control mechanism,
wherein the connecting positioning assembly comprises a connecting positioning post and a positioning hole, the connecting positioning being is arranged on an inner side wall of the vaporization shell and extending in an axial direction of the vaporization shell, and
wherein the positioning hole is arranged on the liquid flowing control mechanism corresponding to the connecting positioning post and configured to be engaged with the connecting positioning post.

8. The vaporizer of claim 1, wherein the vaporization shell comprises an opening, and
wherein the protective assembly comprises a conductive structure arranged close to an opening of the vaporization shell and being driven into rotation by the rotation of the vaporization shell so that the vaporization assembly is electrically connected to or disconnected from the power supply assembly of the electronic vaporization device.

9. The vaporizer of claim 8, wherein the vaporization assembly comprises a conductive component, the conductive structure comprises a movable member and at least one conductive member, the movable member is linked with the vaporization shell, the at least one conductive member is arranged on the movable member, and the at least one conductive member is driven by the rotation of the movable member to contact the conductive component and an electrode on the power supply assembly such that the conductive component is electrically connected to the power supply assembly, or the at least one conductive member is driven by the rotation of the movable member not to contact the conductive component and/or the electrode on the power supply assembly such that the conductive component is disconnected from the power supply assembly.

10. The vaporizer of claim 9, wherein the movable member comprises a disc body arranged coaxially with the vaporization shell, and a center of the disc body is located on an axis of the vaporization shell.

11. The vaporizer of claim 9, wherein a mounting limit assembly is arranged on the movable member and the vaporization shell, and
wherein the mounting limit assembly comprises a limiting engagement groove and a limiting engagement protrusion, the limiting engagement groove being arranged on a side wall of the movable member, and the limiting engagement protrusion being arranged on the vaporization shell and extending away from the vaporization shell in an axial direction from an opening of the vaporization shell, and is arranged corresponding to the limiting engagement groove and configured to be engaged with the limiting engagement groove.

12. The vaporizer of claim 9, wherein the at least one conductive member comprises an elastic sheet structure.

13. The vaporizer of claim 12, wherein the at least one conductive member comprises a first abutting portion configured to abut against the conductive component, a second abutting portion configured to abut against the electrode, and a connection portion configured to connect the first abutting portion to the second abutting portion.

14. The vaporizer of claim 13, wherein the first abutting portion is bent relative to the connection portion, and the first abutting portion comprises an arc-shaped structure protruding away from the movable member.

15. The vaporizer of claim 14, wherein the at least one conductive member comprises two conductive members, and first abutting portions of the two conductive members extend in opposite directions.

16. The vaporizer of claim 14, wherein the at least one conductive member comprises two conductive, and first abutting portions of the two conductive members extend in a same direction.

17. The vaporizer of claim 1, wherein the protective assembly comprises an air inlet control mechanism, the air inlet control mechanism comprises a movable member and a communication airway, the movable member is linked with the vaporization shell, the communication airway is arranged on the movable member, and the vaporization shell is driven into rotation by the movable member such that external air enters the vaporization assembly or the external air is prevented from entering the vaporization assembly by the movable member.

18. The vaporizer of claim 17, wherein the communication airway comprises an airflow through hole arranged on the movable member.

19. The vaporizer of claim 18, wherein the airflow through hole comprises a waist-shaped hole.

20. An electronic vaporization device, comprising:
a power supply assembly comprising a support and an air inlet hole in communication with outside arranged on the support; and
the vaporizer of claim 1,
wherein the vaporizer is connected to the power supply assembly, and
wherein the protective assembly of the vaporizer comprises the air inlet control mechanism, the air inlet control mechanism comprises the movable member and the communication airway arranged on the movable member, the movable member is linked with the vaporization shell, and, when the movable member is driven into rotation by rotation of the vaporization shell, the communication airway is at least partially in communication with the air inlet hole or completely misaligned with the air inlet hole.
